(19) United States
(12) Patent Application Publication
(10) Pub. No.: US 2025/0187305 A1
(43) Pub. Date: Jun. 12, 2025

(54) BITUMINOUS MEMBRANES WITH REFLECTIVE OUTER COATING

(71) Applicant: SAINT-GOBAIN ADFORS, COURBEVOIE (FR)

(72) Inventors: Léo SIMONIN, AUBERVILLIERS (FR); Karl RIVIERE, AUBERVILLIERS (FR)

(21) Appl. No.: 18/840,182

(22) PCT Filed: Feb. 22, 2023
(86) PCT No.: PCT/FR2023/050250

§ 371 Date: Aug. 21, 2024

(30) Foreign Application Priority Data
Feb. 25, 2022 (FR) 2201670

(51) Int. Cl. B32B 11/10; B32B 5/02; B32B 5/10; B32B 5/26

(52) U.S. Cl. CPC B32B 11/10; B32B 5/022; B32B 5/10; B32B 5/266; B32B 2255/02; B32B 2255/26; B32B 2262/0276; B32B 2262/101; B32B 2262/16; B32B 2264/1022; B32B 2307/4023; B32B 2307/416; B32B 2307/718; B32B 2419/06

(57) ABSTRACT

A bituminous sealing membrane includes a bituminous layer and a surface finish in contact with the bituminous layer, the surface finish including a fibrous structure including a non-woven cloth made of glass fibers and/or polyester fibers, the lower face of which is in contact with the bituminous layer and, on the upper surface of the non-woven cloth that is not in contact with the bituminous layer, a white coating including from 0.3 to 6% by weight of TiO₂ particles, from 70 to 90% by weight of one or more white mineral loads and from 8 to 25% by weight of an organic polymer free of carbon-carbon double bonds, the percentages being expressed as dry weight relative to the total dry weight of the white coating. The fibrous structure of the surface finish further includes reinforcement fibers and the bituminous sealing membrane is free of other fibrous structures.

The present invention concerns a white-colored bituminous sealing membrane for roofs, featuring a single fibrous structure reinforced by continuous fibers.

Combined with population growth and urban densification, climate change will make the phenomenon of urban heat islands (UHI) more prevalent, that is, higher air and surface temperatures in city centers than in suburbs and rural areas, particularly at night. As this phenomenon progresses, building air-conditioning costs will rise.

The formation of urban heat islands is due to the significant absorption of solar radiation by the materials that make up city surfaces, such as concrete, cement, asphalt, bitumen, metals, etc. The energy absorbed during the day is transmitted by conduction throughout the volume of the material and emitted as thermal radiation (IR) during the night.

Research has been underway for many years to significantly reduce the absorption of solar radiation by urban surfaces, particularly building roofs, by increasing the reflective properties of these surfaces.

Within the framework of these developments, three parameters were defined in order to compare the behavior of different materials with respect to solar radiation:

Reflectivity or solar reflectance (SR) expresses the capacity of a surface to reflect solar radiation. This is the ratio of solar energy reflected by the surface of a material to the incident energy. SR is therefore equal to 0 when radiation energy is totally absorbed, and equal to 1 when the surface reflects all solar radiation. SR is determined in accordance with the EN410 (2011) standard.

Thermal emissivity (TE) characterizes the ability of a surface to re-emit absorbed energy in the form of infrared thermal radiation. TE can be calculated in accordance with the EN 12898 standard.

Finally, the ASTM E1980 standard defines a solar reflective index (SRI) calculated from the two parameters SR and IE above using the formula

$$SRI = 123.97 - 141.35 χ + 9.655 {χ}^{2} \qquad [ math 1 ]$$

$$with$$

$$χ = \frac{( α - 0.029 ϵ ) ( 8.797 + {h}_{c} )}{9.5205 ϵ + {h}_{c}} \qquad [ math 2 ]$$

where α is solar absorbance (1−solar reflectance), ε is thermal emissivity and h_{c} is a convection coefficient whose value depends on the force of the wind.

Cool roofs are particularly widespread in the USA, where the Cool Roof Rating Council (CRRC) was set up to develop methods for determining SR and IE parameters for the various roofing materials available on the market, and to promote knowledge in the field of cool roofs.

A federal certification, called EnergyStar, setting out requirements for cool roofs, has been created by the US Environmental Protection Agency (EPA). Some states, such as California, have created their own certification (California Title 24).

SRI requirements are generally more stringent for low-slope roofs (less than 2°) than for high-slope roofs visible from the street, for which local legislation often imposes colors. California Title 24 certification requires a solar reflectance (SR) of at least 0.63, a thermal emissivity (TE) of at least 0.75 and a solar reflection index of at least 75 for low-slope roofs after accelerated weathering.

The purpose of the present application is to offer bituminous membranes capable of waterproofing low-slope roofs and which, thanks to a white-colored surface finish laminated on one side of the bituminous membrane, have low solar absorption properties (cool roof) and meet the requirements of EnergyStar® and California Title 24 certifications for low-slope roofs.

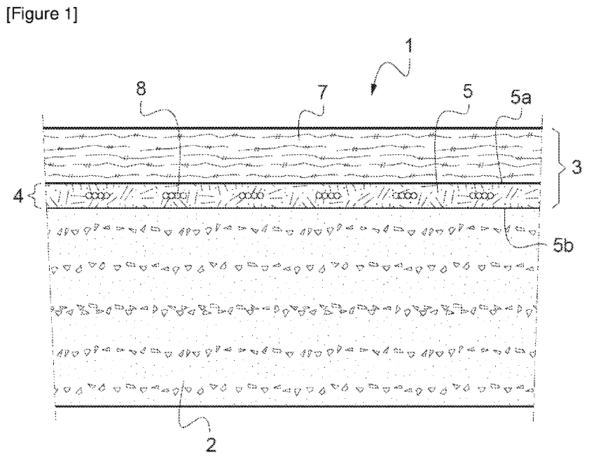

Bituminous membranes of this type have already been described in patent EP1618245B1. They are prepared by applying a white coating composition containing an organic polymer and white mineral fillers and pigments to a fibrous structure, also known as a fiber cloth. Once the white organo-mineral coating has dried, a bituminous membrane is applied to the other side of the fibrous structure. The bituminous membrane application method is described in patent EP 0 876 532 B1. In this process, a first fiber cloth is coated with the surface coating and the coating is dried. A bituminous mass is then applied to the other side of this first fiber cloth coated with the dry coating, and the deposited bituminous layer is then covered with a second fiber cloth, followed by a second bituminous layer (FIG. 1 of EPO 876 532 B1). The resulting sealing membranes thus contain two fiber cloths, respectively a glass fiber non-woven cloth and a polyester fiber non-woven cloth, the polyester fibers being particularly well suited for contact with the bituminous layer. The non-woven glass-fiber cloth guarantees the dimensional stability of the structure during manufacture, particularly when the bituminous mass is applied to the fibrous structure under tension, and also when the sealing membrane is applied to the roof (heat input). Thanks to its elasticity, the non-woven polyester fiber cloth prevents the appearance of cracks over time, which could lead to a leaky roof.

The present invention is based on the discovery that it is possible to prepare white bituminous membranes of this type using a single fiber structure based on non-woven glass fibers and/or polyester fibers, that is, omitting the polyester non-woven cloth present in the bituminous layer of membranes of the state of the art.

To ensure that the final white bituminous membrane has satisfactory dimensional stability when hot and resists cracking and splitting over time, it is necessary to reinforce the non-woven cloth with reinforcement fibers, preferably reinforcing textile glass fibers. These reinforcement fibers, incorporated in the non-woven cloth, make it possible to dispense with a second fibrous structure in the bituminous layer of the membrane of the present invention, thereby simplifying the manufacturing process and reducing manufacturing costs.

The present application relates to a bituminous sealing membrane comprising
a bituminous layer and
a surface finish in contact with the bituminous layer, the surface finish comprising
a fibrous structure comprising a non-woven cloth made of glass fibers and/or polyester fibers, the lower face of which is in contact with the bituminous layer, and
on the upper surface of the non-woven cloth that is not in contact with the bituminous layer, a white coating comprising from 0.3 to 6% by weight of TiO₂ particles, from 70 to 90% by weight of one or more white mineral fillers, and from 8 to 25% by weight of an organic polymer free of carbon-carbon double bonds,
said percentages being expressed as dry weight relative to the total dry weight of the white coating,
said membrane being characterized in that the fibrous structure of the surface finish further comprises reinforcement textile glass fibers and that the bituminous sealing membrane, and notably the bituminous layer, is free of other fibrous structures.

The non-woven cloth of the fibrous structure can be made of glass or polyester fibers or a mixture of glass and polyester fibers. The fibers of the non-woven cloth are preferably polyester fibers, possibly mixed with glass fibers. In the case of a blend, at least 50% by weight, preferably at least 70% by weight, of the fibers in the non-woven cloth are polyester fibers.

The use of polyester fibers in the non-woven cloth improves the static puncture resistance (NF EN 12730) of the bituminous membrane.

The glass and polyester fibers of the non-woven cloth are preferably short fibers with lengths between 2 and 100 mm, preferably between 6 and 80 mm.

The glass and/or polyester fibers forming the non-woven cloth are held together by means of an organic binder, preferably a thermoset organic binder based on phenol-formaldehyde, urea-formaldehyde or melamine-formaldehyde resins or on biobased polyester resins prepared from biobased carbohydrates and polyacids. The binder can also be a styrene-butadiene rubber (SBR) latex-based binder.

As explained in the introduction, the unique fibrous structure of the bituminous membrane of the present invention comprises reinforcement fibers in addition to the glass and/or polyester fiber non-woven cloth. The reinforcement fibers are continuous fibers, that is, of infinite length. These are continuous textile glass fibers, that is, obtained by mechanical drawing using known processes, or continuous polyester fibers.

When continuous fibers are glass fibers, they are made up of individual filaments, bundled together in “base yarns” (also known as “continuous filament” or “strand”). Each base yarn typically contains from 50 to 2000, preferably from 100 to 1600, and in particular from 150 to 500 individual filaments.

The individual filaments advantageously have a diameter of between 5 and 20 μm, preferably between 6 and 16 μm.

The linear mass of the base yarns is typically between 20 and 400 tex, preferably between 50 and 250 tex.

The glass reinforcement fibers are preferably oriented parallel to the length of the fibrous structure web and therefore parallel to the length of the bituminous membrane.

When continuous fibers are made of polyester, they are made up of individual filaments, bundled into “base yarns” (also called “continuous filament” or “strand”). Each base yarn generally contains from 50 to 2000, preferably from 100 to 1600, and in particular from 180 to 450 individual filaments.

The individual filaments advantageously have a diameter of between 5 and 40 μm, preferably between 6 and 30 μm.

The linear mass of the base yarns is typically between 20 and 400 tex, preferably between 50 and 250 tex.

Advantageously, the polyester reinforcement fibers are oriented parallel to the length of the fibrous structure web and therefore parallel to the length of the bituminous membrane but can also be oriented at a fairly large angle (typically greater than 70°) relative to the length of the bituminous membrane.

The membrane's single fiber structure, whether made of glass or polyester fibers, preferably has a sandwich structure with a layer of reinforcement fibers located between two layers of short fibers bonded into a non-woven cloth.

The reinforcement fibers are preferably glass fibers.

The fibrous structure comprising the non-woven cloth and reinforcement fibers advantageously has a weight per unit area of between 30 and 500 g/m², preferably between 50 and 350 g/m².

When the non-woven cloth comprises both textile glass fibers and polyester fibers, the weight ratio of glass fibers to polyester fibers is between 0.05 and 1.5, preferably between 0.1 and 1.

The manufacture of bituminous membranes of the present invention involves a first step of manufacturing a white surface finish, consisting of the fibrous structure (reinforced non-woven cloth) and the white coating. An aqueous coating composition containing organic polymer, white mineral fillers and TiO₂ particles is applied to the fibrous structure.

The coating composition can be prepared by mixing from 10 to 30% by weight of water, from 50 to 65% by weight of white mineral fillers, from 10 to 30% by weight of organic polymer latex free of carbon-carbon double bonds and from 0.2 to 5% of TiO₂ particles, these percentages being based on the total weight of the aqueous coating composition.

The coating composition can also comprise other additives such as a dispersing agent to ensure good dispersion of pigments and mineral fillers. This product is generally a solution containing a high-molecular-weight copolymer with good affinity for the pigment.

A thickener can also be added to the coating composition to adjust its viscosity. This rheology modifier is often organic and can be cellulosic or synthetic (associative or non-associative).

Lastly, other additives can be introduced into the composition, such as biocides, foam-limiting compounds, flame retardants, an aqueous wax emulsion providing a hydrophobic character to the fibrous structure, or additives increasing the UV resistance of the surface (UV absorbers or photostabilizing compounds).

White-colored mineral fillers are preferably selected from the group consisting of CaCO₃, wollastonite, silica, kaolin, talc, barium sulfate, bentonite, zirconia, mica and quartz. These mineral fillers preferably have median sizes of between 1 μm and 100 μm.

TiO₂ particles advantageously have a median volume size (D₅₀), determined by laser granolumetry, of between 200 and 800 nm.

The organic polymer free of carbon-carbon double bonds is preferably selected from the group consisting of acrylic polymers, aliphatic polyurethanes, fluorinated or chlorinated polymers, and polyvinyl butyral. Aqueous dispersions of such polymers are available, for example, under the trade names AC2025 and AC2077 (Alberdingk), Pilotec® LEB20 (Omnova Solutions), Orgal® P838W and Orgal® P850RR (Monokem Kimya), Primal® AC (Dow), for acrylic polymers; U400N (Alberdingk), for aliphatic polyurethanes; Kynar Aquatec® (Arkema) for fluorinated or chlorinated polymers; Shark Dispersion® MW2, WX2 or FX2 (Shark Solutions) for polyvinyl butyral dispersions. The absence of carbon-carbon double bonds is interesting from the point of view of the longevity of the membrane's reflectivity.

The reflective properties of the dried white coating depend on the respective proportions of the mineral particles (TiO₂ and white fillers), on the one hand, and the organic polymer, on the other. Increasing the organic polymer fraction limits the final porosity of the white coating, improving surface reflectivity and extending coating life. However, TiO₂ and white fillers are highly reflective and must therefore be present in sufficient quantity. The Applicant found that reflective properties were optimal when the ratio by weight of all mineral particles (that is, TiO₂ and mineral fillers) to the organic polymer was between 1.5 and 2.5, preferably between 1.6 and 2.4 and ideally between 1.8 and 2.2.

The coating composition is deposited on the fibrous structure, for example by knife coating. This application is carried out in such a way that the other side of the fibrous structure remains free to receive the bituminous layer.

After application of the coating composition, the structure is dried, for example for 0.5 to 5 minutes at a temperature of between 10° and 200° C.

The dried surface finish thus obtained (comprising the fibrous structure and the white coating) has a surface density of between 200 and 800 g/m², preferably between 250 and 750 g/m², in particular between 300 and 700 g/m². It can be rolled up, stored and/or transported for subsequent coating with the bituminous layer.

Thanks to the presence of continuous textile glass fibers incorporated in the non-woven cloth, the surface finish will have excellent dimensional stability and will not deform during the stage of applying the hot bituminous mass, even when the fibers of the non-woven cloth are predominantly polyester fibers.

The bituminous sealing membrane of the present invention has a weight per unit area of between 3 and 5.5 kg/m².

The invention is illustrated in FIG. 1, which shows a cross-section of a bituminous membrane according to the invention.

This bituminous membrane 1 comprises a fibrous structure 4 formed by a non-woven cloth 5 having an upper face 5a and a lower face 5b, and continuous reinforcing glass fibers 8 arranged parallel to one another at the core of the non-woven cloth 5. The reinforcement fibers 8 are base yarns made up of a plurality of individual filaments. The upper face 5a of the fibrous structure 4 is in contact with a white coating 7 formed from mineral particles (TiO₂ and white-colored mineral fillers, not shown) bonded by an organic polymer. The lower face 5b of the fibrous structure 4 is in contact with a bituminous layer 2. The bituminous layer contains no fibrous structure.

1. A bituminous sealing membrane comprising:
a bituminous layer and
a surface finish in contact with the bituminous layer, the surface finish comprising
a fibrous structure comprising a non-woven cloth made of glass fibers and/or polyester fibers, a lower face of the non-woven cloth is in contact with the bituminous layer, and
on an upper surface of the non-woven cloth that is not in contact with the bituminous layer, a white coating comprising from 0.3 to 6% by weight of TiO₂ particles, from 70 to 90% by weight of one or more white mineral fillers, and from 8 to 25% by weight of an organic polymer free of carbon-carbon double bonds,
said percentages being expressed as dry weight relative to the total dry weight of the white coating,
wherein the fibrous structure of the surface finish further comprises reinforcement fibers and wherein the bituminous sealing membrane, and notably the bituminous layer, is free of other fibrous structures.

2. The bituminous sealing membrane according to claim 1, wherein the reinforcement fibers are reinforcement textile glass fibers.

3. The bituminous sealing membrane according to claim 2, wherein the reinforcement textile glass fibers are made up of individual filaments, bundled into base yarns, each base yarn containing from 50 to 2000 individual filaments.

4. The bituminous sealing membrane according to claim 2, wherein the individual filaments have a diameter of between 5 and 20 μm.

5. The bituminous sealing membrane according to claim 1, wherein the reinforcement fibers are polyester fibers.

6. The bituminous sealing membrane according to claim 5, wherein the polyester reinforcement fibers are made up of individual filaments, bundled into base yarns, each base yarn containing from 50 to 2000 individual filaments.

7. The bituminous sealing membrane according to claim 5, wherein the individual filaments have a diameter of between 5 and 40 μm.

8. The bituminous sealing membrane according to claim 1, wherein the bituminous sealing membrane has a sandwich structure with a layer of reinforcement fibers located between two layers of short fibers assembled into a non-woven cloth

9. The bituminous sealing membrane according to claim 1, wherein the fibrous structure comprising the non-woven cloth and the continuous reinforcement fibers has a mass per unit area of between 30 and 500 g/m².

10. The bituminous sealing membrane according to claim 1, wherein the surface finish comprising the fibrous structure and the white coating has a mass per unit area of between 200 and 800 g/m².

11. The bituminous sealing membrane according to claim 1, wherein the organic polymer is selected from the group consisting of acrylic polymers, aliphatic polyurethanes and fluorinated or chlorinated polymers.

12. The bituminous sealing membrane according to claim 1, wherein the white mineral fillers are selected from the group consisting of CaCO₃, wollastonite, silica, kaolin, talc, barium sulfate, bentonite, zirconia, mica and quartz.

13. The bituminous sealing membrane according to claim 1, wherein the bituminous sealing membrane has a mass per unit area of between 3 and 5.5 kg/m².

14. The bituminous sealing membrane according to claim 1, wherein the TiO₂ particles have a median volume size (D₅₀), determined by laser granolumetry, of between 200 and 800 nm.

15. The bituminous sealing membrane according to claim 3, wherein each base yarn contains from 100 to 1600 individual filaments.

16. The bituminous sealing membrane according to claim 4, wherein the individual filaments have a diameter of between 6 and 16 μm.

17. The bituminous sealing membrane according to claim 6, wherein each base yarn contains from 100 to 1600 individual filaments.

18. The bituminous sealing membrane according to claim 7, wherein the individual filaments have a diameter of between 6 and 30 μm.

19. The bituminous sealing membrane according to claim 9, wherein the mass per unit area is between 50 and 350 g/m².

20. The bituminous sealing membrane according to claim 10, wherein the mass per unit area is between 250 and 750 g/m².
